(19) United States
(12) Patent Application Publication
(10) Pub. No.: US 2010/0025154 A1
(43) Pub. Date: Feb. 4, 2010

(54) MODULAR LADDER

(75) Inventor: Sang Jin Kim, Renton, WA (US)

Correspondence Address: BLACK LOWE & GRAHAM, PLLC, 701 FIFTH AVENUE, SUITE 4800, SEATTLE, WA, 98104, US

(73) Assignee: Advanced Ladders, Kent, WA (US)

(21) Appl. No.: 12/576,651

(22) Filed: Oct. 9, 2009

Related U.S. Application Data
(63) Continuation of application No. 11/566,946, filed on Dec. 5, 2006, now abandoned.
(60) Provisional application No. 60/758,720, filed on Jan. 13, 2006.

(51) Int. Cl. E06C 1/38

(52) U.S. Cl. 182/178.4; 182/178.2

(57) ABSTRACT

A modular ladder system is provided, wherein segments may be joined without limit to form a ladder of any desired length.

### PRIORITY CLAIM

The present application is a continuation of U.S. Utility application Ser. No. 11/566,946 filed Dec. 5, 2006 which claims priority from U.S. Provisional Application No. 60/758,720 filed Jan. 13, 2006, both of which are herein incorporated by reference.

### FIELD OF THE INVENTION

This invention relates generally to ladders and, more specifically, to an extendable ladder of modular sections.

### BACKGROUND OF THE INVENTION

Ladders are made in various sizes. A shorter ladder allows easier transportation, handling, and storage, but is limited in usefulness to tasks that may be accomplished with a shorter ladder. When a ladder is too short for its intended use, the user must get a longer ladder. A longer ladder may be used in more situations, but is harder to transport and store. While extension ladders address these problems to some degree, they still have drawbacks such as complex latching devices, and also have a maximum height. A need exists for a ladder system of adjustable length which may be used in situations where a longer ladder is needed and which may be easily stored and transported.

### SUMMARY OF THE INVENTION

A modular ladder system is provided, including segments of ladder which may be easily fitted together as needed to provide a variable length ladder.

The present invention comprises a modular ladder system comprising a slide-in (male) segment and a slide-around (female) segment, wherein the segments may operably connect to form a ladder.

In accordance with further aspects of the invention, the rails of the male and female sections comprise three sides such that the male segment will slide in the female segment, and the female segment will slide around the male segment, until the rails of the male segment contact a rung of the female segment and are supported by the rung. In this way, the segments may be operably connected and form a ladder.

In accordance with other aspects of the invention, additional male and female segments are provided which may be operably connected to the ladder system of the present invention to form a ladder of any desired height. Additionally, female and male segment are provided which may be operably connected to any ladder system of conventional single or extension ladder system to form a ladder of any desired height.

In accordance with still further aspects of the invention, a folding ladder segment is provided which may be operably connected to a male and a female segment to form a folding ladder.

In accordance with yet other aspects of the invention, a scaffold segment is provided which may be operably connected to a male and a female segment to form a scaffold.

In accordance with still another aspect of the invention, a connector and two substantially similar segments are provided, such that the connector may operably connect with each segment to form a ladder.

In accordance with a further aspect of the invention, segments having a male end and a female end are provided, such that the male ends of the segments may connect to the female ends of other segments, and the female ends of the segments may connect with the male ends of other segments, such that the segments may form a ladder.

As will be readily appreciated from the foregoing summary, the invention provides a modular ladder system which may be assembled to form various types of ladders of any desired length.

### BRIEF DESCRIPTION OF THE DRAWINGS

Preferred and alternative embodiments of the present invention are described in detail below with reference to the following drawings.

FIG. 1 shows a male and a female segment of the present invention positioned to operably connect;

FIG. 2 shows a cross-section of a male and a female segment operably connected;

FIG. 3 shows a folding ladder section of an embodiment of the present invention;

FIG. 4 shows a scaffold section of an embodiment of the present invention;

FIG. 5 shows a connector and segments of an embodiment of the present invention;

FIG. 6 shows a cross-section of a connector and segment; and

FIG. 7 shows a ladder segment of an embodiment of the present invention having a pair of male rail ends and a pair of female rail ends.

### DETAILED DESCRIPTION OF THE PREFERRED EMBODIMENT

Although specific terms are used in the following description for the sake of clarity, these terms are intended to refer only to the particular structure of the invention selected for illustration in the drawings, and are not intended to define or limit the scope of the invention.

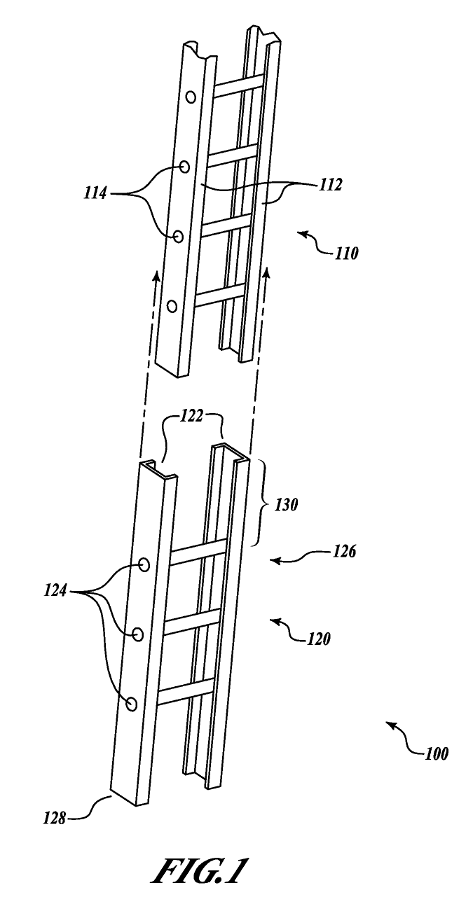

Referring now to the drawings, FIG. 1 shows male 110 and female 120 segments of an embodiment of the invention 100 positioned to operably connect to form a ladder. The male segment 110 includes rails 112 and a plurality of rungs 114 connecting the rails 112 laterally. The female segment 120 includes rails 122 and a plurality of rungs 124 connecting the rails 122 laterally. The segments 110, 120 operably connect by sliding the rails 122 of the female segment 120 around the rails 112 of the male segment 110 and the rails 112 of the male segment 110 into the rails 122 of the female segment 120, until the rails 112 of the male segment contact the first rung 126 of the female segment 120.

Note that while the length of the rails of a prior art ladder (not shown) extend one foot or less beyond a bottom or top rung of the ladder, the length 130 of the rails 122 of the female segment 120 that extend beyond a top or bottom rung 126 is sufficient to provide security and stability to the ladder system 100 when the segments 110, 120 are operably connected. Additionally, the rungs 126 of the female segment 120 may be strengthened so as to be able to support additional ladder segments 110, 120. Note also that the female segment 120 may be used with a conventional ladder (not shown) having a cross-section which will fit in the rails 122 of the female segment 120. In this case, the first rung 126 of the female segment 120 contacts and supports the rails of the conventional ladder the same way the first rung 126 supports the male segment 110. That is, any conventional ladder with rails that are sized and shaped to fit inside the rails 122 of the female segment 120 may be used as a male segment 110.

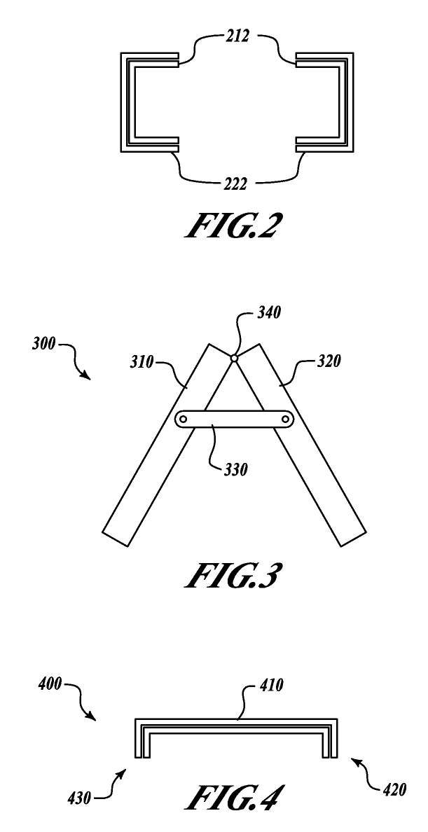

FIG. 2 shows a cross-section of the segments of FIG. 1 operably connected. In this embodiment, both male and female rails 212, 222 are three-sided, and are sized such that the male rails 212 may easily slide into the female rails 222 and such that the joined segments 210, 220 may form a secure and stable connection. While no locking system is required, conventional locking systems such as tongue and groove combinations or pins (not shown) may be included as desired. Note that the rails 212, 222 may have a variety of cross-sections.

As may be seen in FIG. 1, the unconnected end 128 of the female segment 120 may be operably coupled to an additional male segment (not shown), and the unconnected end 118 of the male segment 110 may be operably coupled to an additional female segment (not shown). In this way, alternating segments 110, 120 may be operably coupled to the ladder system 100 until a desired ladder length is achieved.

FIG. 3 shows a further embodiment of the present invention, a folding ladder segment 300. The folding ladder segment 300 comprises a male segment 310, a female segment 320, and a pair of connectors 330. The segments 310, 320 are connected at an end 340, and each connector 330 is hinged, with opposite ends of the connector 330 attached to the segments 310, 320, such that the segments may be positioned together such that they are substantially parallel (not shown), or may be positioned apart (as shown in FIG. 3). The male segment 310 is configured to operably connect to a female segment 120 of the embodiment shown in FIG. 1, and the female segment 320 is configured to operably connect to a male segment 110 of the embodiment shown in FIG. 1, such that the segments 300, 110, 120 may form a folding ladder.

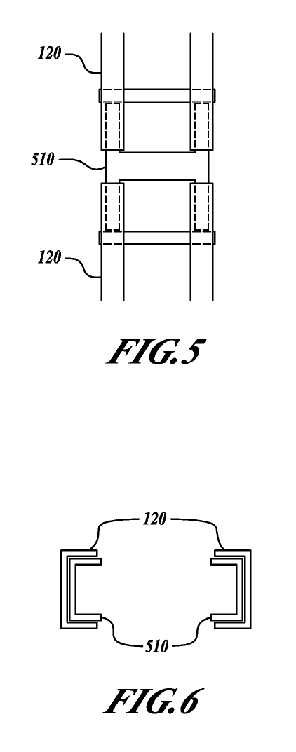

FIG. 4 shows an additional embodiment of the invention, a scaffold segment 400. The scaffold segment comprises a platform 410, a female segment 420, and a male segment 430. The female segment 420 may be operably coupled with a male segment 110 of the embodiment shown in FIG. 1, and the male segment 410 may be operably coupled with a female segment 120 of the embodiment shown in FIG. 1, such that the segments 400, 110, 120 may form a scaffold.

FIG. 5 shows another embodiment 500 of the present invention. This embodiment 500 comprises two or more female segments 120 of the embodiment shown in FIG. 1, and a male connector 510. Each connector 510 is configured to operably couple two female segments 120. Additional connectors 510 and segments 120 may be added to the system as needed until a desired ladder length is attained.

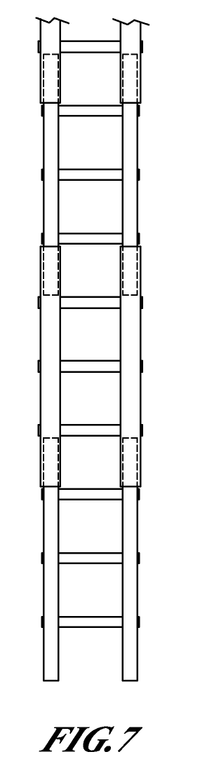

FIG. 6 shows a cross-section of a segment 120 and a connector 510 operably coupled. In an additional embodiment, the connector 510 may comprise a pair of two-by-fours.

FIG. 7 shows an additional embodiment of the present invention. In this embodiment, the segments 810 are substantially identical. Each segment 810 has a female pair of rail ends 840 and a male pair of rail ends 850. The rail ends 840 of the female end 820 of the segment 810 are configured to slide around a pair of male rail ends, and the rail ends 850 of the male end 830 of the segment 810 are configured to slide into a pair of female rail ends until contacting a rung 860 of the female end 820. In this way, additional segments 810 may be coupled to the first segment 810 to form a ladder of the desired length. This embodiment allows easier incorporation of conventional ladder segments into the ladder.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. (canceled)

2. (canceled)

3. (canceled)

4. (canceled)

5. The system of claim 1, further comprising a folding ladder section, wherein the first and second pairs of rails may be operably connected to the folding ladder section to form a folding ladder.

6. The system of claim 5, further comprising additional first and second pairs of rails, wherein the additional first and second pairs of rails may be operably connected to the folding ladder to form a longer folding ladder.

7. (canceled)

8. (canceled)

9. The system of claim 1, wherein each of the first pair of rails has an H-shaped cross-section, and each of the second pair of rails has a C-shaped cross-section such that the first pair may slide into the second pair, and the second pair may slide around the first pair, and a rung of the second pair may support the first pair.

10. The system of claim 1, wherein one pair of rail ends of the first pair of rails is configured to slide around a pair of rail ends of the second pair of rails, and the other pair of rail ends of the first pair of rails is configured to slide in the other pair of rail ends of the second pair of rails, and wherein a pair of rail ends of the second pair of rails is configured to slide in a pair of rail ends of the first pair of rails, and the other pair of rail ends of the second pair of rails is configured to slide around the other pair of rail ends of the first pair of rails, such that the first and second pairs of rails may be operably connected to form a ladder.

11. (canceled)

12. (canceled)

13. (canceled)

14. (canceled)

15. The system of claim 11, wherein the connector may have a two-inch by four-inch cross-section.

16. The system of claim 11, wherein the connector may be a pair of two-by-fours.

17. A method comprising sliding a first pair of rails into a second pair of rails until the first pair of rails contacts a rung of the second pair of rails.

18. The method of claim 17, further comprising sliding an additional first pair of rails into the opposite ends of the second pair of rails until the first pair of rails contacts a rung of the second pair of rails.

19. A ladder comprising:
a first ladder section having a first pair of rails connected together by at least a pair rungs oriented substantially orthogonal relative to the rails, the first ladder section having a first cross-sectional shape extending from an insertable portion having a first length with a rung contact surface; and
a second ladder section having a second pair of rails connected together by at least a second pair of rungs oriented substantially orthogonal to the second pair of rails, the second ladder having a second cross-sectional shape configured to be nestably and similarly shaped with respect to the first cross-sectional shape of the first ladder section, the second ladder section further having a receiving portion with a second length configured to receivably accept at least the first length of the insertable portion by an amount in which the rung contact surface makes contact with one of the second pair of rungs.

20. The ladder of claim 19 wherein the first length and the second length are about equal.

21. The ladder of claim 19 wherein the first length and the second length are substantially equal.

22. The ladder of claim 19 wherein the nested cross-sectional shapes are selected to maximize to an out-of-plane sectional bending modulus of the ladder within a range of at least one of the first or second lengths.

23. The ladder of claim 19 wherein the nested cross-sectional shapes are selected to be C-shaped channels.

24. The ladder of claim 23 wherein end surfaces of the outstanding flanges of the C-shaped channels for each ladder section are approximately flush with each other.

25. The ladder of claim 19 further comprising a third ladder section configured to be supportively received by one of the first or section ladder sections.

26. The ladder of claim 19 further comprising:
a third ladder section configured with dimensions substantially similar to the second ladder section; and
a connector receivable by both the second and third ladder sections for operably coupling the two ladder sections together.
